(19) United States
(12) Patent Application Publication
(10) Pub. No.: US 2007/0146707 A1
(43) Pub. Date: Jun. 28, 2007

(54) Pattern inspection apparatus and method along with workpiece tested thereby and management method of workpiece under testing

(75) Inventor: Kenichi Matsumura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Advanced Mask Inspection Technology Inc., Kawasaki-shi (JP)

(21) Appl. No.: 11/378,333

(22) Filed: Mar. 20, 2006

(30) Foreign Application Priority Data
Dec. 27, 2005 (JP) 2005-373900

(51) Int. Cl. G01B 11/00

(52) U.S. Cl. 356/394

(57) ABSTRACT

A pattern inspection apparatus for inspecting deterioration of the optical image of a workpiece to be tested is disclosed. The apparatus includes an image acquisition unit operable to capture an optical image of a workpiece under testing, a first memory for storing therein the workpiece image as a fiducial or “base” image, a second memory for receiving after acquisition of the base image another workpiece image gained by the image acquisition unit and for storing it as an image to be tested, and a comparison processor unit for comparing the test image to the base image. The workpiece base image that was read out of the first memory is compared to the test image of the workpiece as read from the second memory. A pattern inspection method and a workpiece obtained thereby along with a workpiece management methodology are also disclosed.

### CROSS-REFERENCE TO RELATED APPLICATION(S)

The subject application claims benefit of the earlier filing date of Japanese Patent Application (JPA) No. 2005-373900, filed on Dec. 27, 2005, the entire contents of which are incorporated herein by reference.

### FIELD OF THE INVENTION

The present invention relates generally to workpiece pattern inspection technologies and, more particularly, to a method and apparatus for inspecting circuit patterns of workpieces including, but not limited to, wafers of highly integrated semiconductor devices and liquid crystal display (LCD) panels or photomasks, called reticles, adapted for use in the manufacture thereof. This invention also relates to a workpiece which is tested by the pattern inspection method and apparatus and to a management method of the same.

### DESCRIPTION OF RELATED ART

Prior known pattern inspection apparatus is typically designed to perform inspection by comparing together optical images of patterns formed on workpieces, such as reticles, which images are captured at specified magnification, or alternatively by comparing this optical pattern image to a reference image that is obtained from design data. An example of this approach is disclosed, for example, in Published Unexamined Japanese Patent Application No. 8-76359. Currently available pattern inspection methodology employs several techniques, one of which is die-to-die (DD) inspection, and another of which is die-to-database (DB) inspection. The DD inspection is for comparing together optical images which are gained from identical patterns on the same reticle at different locations. The DB inspection is a method having the steps of preparing from the reticle design data a reference image with much similarity to an optical image as drawn on a reticle and for comparing an optical image to this reference image to thereby inspect a reticle pattern for defects. With either one of these inspection methods for use in pattern inspection apparatus, a target workpiece is mounted on a stage, which is driven to move whereby a beam of light scans a top surface of the workpiece so that pattern inspection is performed. A light source and its associated illumination optics are used to irradiate and guide the light beam to fall onto the workpiece surface. Light that passed through or was reflected from the workpiece is focused onto a photosensor via optics. An optical image picked up by the sensor is then sent forth to a comparator circuit as measurement data. This comparator circuit compares optical images together or an optical image to the reference image in accordance with appropriate algorithm after having performed position alignment of these images. If mismatch or inconsistency is found therebetween, then the pattern being inspected is determined to be defective. Unfortunately, this pattern inspection method is encountered with difficulties in adequately detecting deterioration or “corruption” of reticle images.

### BRIEF SUMMARY OF THE INVENTION

It is therefore an object of this invention to provide a technique for inspecting image deterioration of a workpiece to be inspected.

It is another object of the invention to provide a technique for promptly detecting degradation of the image of a workpiece being inspected.

It is a further object of the invention to provide a method and apparatus capable of detecting workpiece image deterioration and also a workpiece obtained thereby along with a management method thereof.

In accordance with one aspect of the invention, a pattern inspection apparatus includes an optical image acquisition unit operable to gain the optical image of a workpiece to be inspected, a fiducial image storage memory device which stores therein the optical image of the workpiece as a fiducial image, a test image storage memory device for receiving after acquisition of the fiducial image another optical image of the workpiece obtained by the optical image acquisition unit and for storing therein this optical image as an image to be tested, and a comparison processing unit for comparison between the fiducial image and the image to be tested. The fiducial image of the workpiece as read out of the fiducial image storage memory device is compared to the to-be-tested image of the workpiece as read out of the test image storage memory device.

In accordance with another aspect of the invention, a pattern inspection method includes the steps of gaining as an image to be tested an optical image of a workpiece being inspected, and comparing the test image to an optical image of the workpiece as has been previously acquired as a fiducial image.

In accordance with further aspect of the invention, a pattern inspection method includes the steps of gaining as an image to be tested an optical image of a workpiece being inspected, and comparing the test image to an optical image of the workpiece as has been previously acquired as a fiducial image, wherein the test image is gained through calibration of an optical image acquisition unit to a state at the time the fiducial image was gained by said optical image acquisition unit.

In accordance with a further aspect of the invention, a workpiece is provided, which was obtained by comparison of a fiducial image of a workpiece under inspection as obtained in past and a test image as acquired during inspection of the workpiece.

In accordance with another further aspect of the invention, a workpiece management method is provided which includes the steps of acquiring an optical image of a workpiece under testing as an image to be tested, and comparing the test image to an optical image of the workpiece which has been acquired previously.

### BRIEF DESCRIPTION OF THE FIGURES OF THE DRAWING

FIG. 1 is a diagram showing a basic configuration of a pattern inspection apparatus embodying the invention.

FIG. 2 illustrates, in detailed block diagram form, an arrangement of the pattern inspection apparatus.

FIG. 3 depicts a perspective view of a reticle in the process of scanning an image thereof.

FIG. 4 is a block diagram showing a configuration of a comparison processor unit of the pattern inspection apparatus.

FIG. 5 is a flow diagram of reticle pattern inspection.

FIGS. 6A to 6C are flow diagrams each showing an inspection procedure of a fiducial image and a pattern image to be tested.

FIGS. 7A an d 7B are diagrams each showing a procedure for saving a fiducial image and for inspection of an image being tested.

FIGS. 8A-8B are diagrams each showing a parallel processing-based inspection procedure by comparison of a fiducial image and an image being tested.

FIGS. 9A-9B are diagrams each showing a parallel processing-based inspection scheme using a local fiducial image storage memory device.

FIGS. 10A-10B are diagrams each showing a parallel-processed fiducial-image/test-image inspection scheme using a calibration data storage memory device.

### DETAILED DESCRIPTION OF THE INVENTION

An explanation will now be given of the pattern inspection of a workpiece to be tested, such as a reticle, in accordance with an embodiment of the invention.

A pattern inspection technique embodying the invention is arranged in principle to gain an optical image of a workpiece with maximal excellence in quality and then save it as a fiducial or “standard” image. Thereafter, capture, as an image to be inspected, an optical image with the possibility that the workpiece being tested becomes inferior in quality—i.e., deteriorable. Then, compare the to-be-inspected image to the fiducial image for inspecting the former image to thereby determine its deterioration state. Embodiments of the invention as will be described below relate to a method and apparatus for inspecting workpiece pattern image deterioration along with a workpiece obtained through the inspection and a management method of workpieces to be inspected.

The fiducial image is an optical image which has been acquired in the past from a workpiece to be inspected. The fiducial image is the one that was acquired prior to deterioration inspection of the optical image—for example, an optical image of the maximal excellence in the manufacture of the workpiece being tested, at the time of product delivery inspection in manufacturing facility or in the event of initial inspection at the time of product acceptance check. Inspection conditions and test results at the time of acquisition of the fiducial image are stored in any given memory device which stores therein calibration data. During deterioration inspection, these inspection conditions or test results stored are used without change or, alternatively, are used in a way pursuant to a degree of deterioration and/or an inspection method used.

A reticle pattern image to be inspected is an optical image that is captured from the same workpiece being inspected after having obtained the fiducial image. An example of the to-be-inspected image is an optical image with the possibility that the image deteriorates due to the usage of the to-be-tested workpiece. Note that the optical image is an image that was acquired at an optical image acquisition unit. Although an explanation will be given under an assumption that the to-be-tested workpiece is a reticle, the workpiece may alternatively be any other types of ones having a surface on which a pattern image is formed, such as for example photomasks, semiconductor wafers or equivalents thereto.

It is very likely that the reticle image deterioration is caused by the so-called “growing defects” on a reticle, which takes place due to ArF and F2 as exposure-use light source modules become shorter in wavelength. In particular, regarding the image deterioration, there are problems which follow. First, at the time a device obtained by exposure begins to have appreciable problems, the reticle deterioration is progressed too extensively, resulting in defects being no longer sufficiently removable even when cleaning is applied thereto. Second, such defects generate probabilistically and thus it is hardly possible to identify defect generation portions. Third, it is deemed effective to perform early defect detection and early-time cleaning to thereby remove the “core” that will give rise to deterioration sooner or later. Fourth, reflection inspection becomes important in view of the fact that the defect generation is due to workpiece surface degradation. Fifth, this deterioration inspection is carried out recurrently, so it is inevitable to shorten the length of an inspection time period and a preparation time. For example, it is a must to provide an ability to urgently perform inspection whenever a deterioration risk is found. Consequently a need is felt to detect as early as possible the occurrence of low-glade or “minor” deterioration by comparison to the initial state in accordance with an accumulated exposure number—for example, the inspection is first performed at an increased length of intervals, and thereafter done at gradually shortened intervals. This problem is readily occurrable especially in the manufacture of highly integrated semiconductor memory devices or central processing units (CPUs), which are relatively large in exposure number per reticle. Additionally the inspection using such time difference is preferably designed to employ an advanced scheme for comparison between images being processed (i.e., simulation images) by use of a large capacity of storage devices.

### Pattern Inspection Apparatus

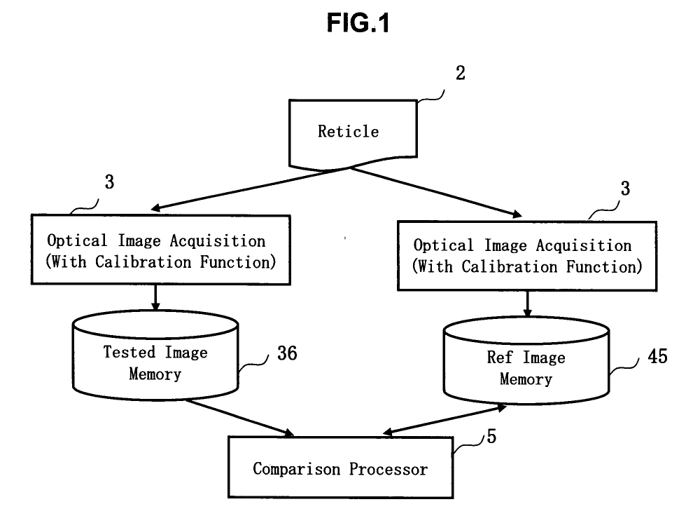

Referring to FIG. 1, a system configuration of pattern inspection apparatus is shown schematically. The illustrative pattern inspection apparatus is generally made up of an optical acquisition unit 3, a memory device 45 for storage of a fiducial image, a buffer memory device 36 for storage of a pattern image to be inspected, and a comparison processing unit 5. The optical image acquisition unit 3 is operable to acquire more than two optical pattern images of the same reticle at specified time intervals. A first captured optical image is for use as a fiducial image, which is stored in the fiducial image storage memory device 45. The next optical image that is gained after the elapse of a time is an image to be inspected, which is stored in the buffer memory 36. The comparison processor 5 compares the fiducial and the to-be-tested images together to thereby inspect a present deterioration state of the to-be-tested image with the fiducial image of no deterioration risks being as a reference for check. By letting this deterioration inspecting functionality be built in ordinary pattern inspection apparatus, it is possible to execute high-sensitivity pattern inspection at high speeds while reducing complexities in reticle degradation test procedure. Preferably, the fiducial image is subjected to detection of defects in an image drawn on a reticle through the processing of DB comparison with a reference image, which is previously obtained from design data (e.g., pattern draw data).

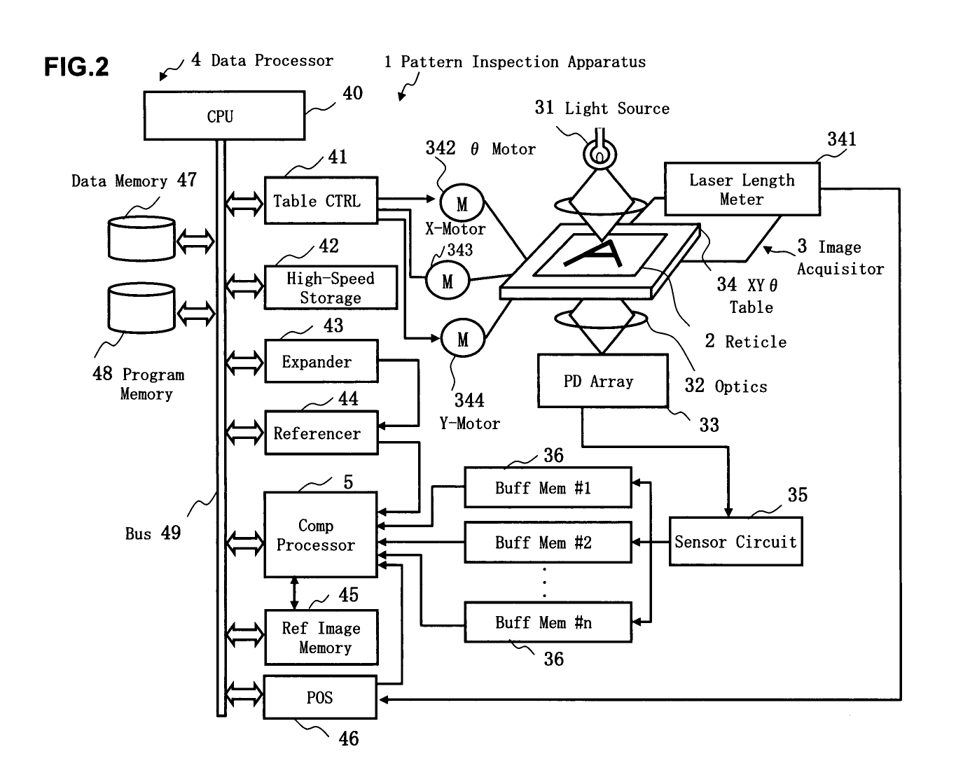

Turning to FIG. 2, an overall configuration of the pattern inspection apparatus 1 is shown in block diagram form. The pattern inspection apparatus 1 is principally configured from the optical image acquisition unit 3 and a data processing unit 4. The optical image acquisitor unit 3 includes as its main components a light source 31, a table structure 34 which mounts thereon a reticle 2 and which is movable in X and Y directions and also rotatable by an angle θ(referred to as “XYθ table” hereinafter), a rotation motor 342 for driving the XYθ table to rotate by a specified angle θ, an X motor 343, a Y motor 344, a laser-assisted length measurement system 341, a magnifying optical system 32, a photodiode (PD) array 33, a sensor circuit 35, and the buffer memory 36. The data processor unit 4 generally includes a central processing unit (CPU) 40, a data transfer bus 49, a table control unit 41 for control of motion and rotation of the XYθ table 34, a data storage memory 47, a program storage memory 48, a high-speed storage device 42, an expander unit 43, a referencing unit 44, the comparison processing unit 5, the fiducial image storing memory device 45, and a position unit 46. The expander 43 and reference unit 44 are connected via the bus 40 of CPU 40 to external storage devices of the data memory 47 and program memory 48. Examples of the external storage devices are magnetic disk drives, optical disc drives, magneto-optical disc drives, magnetic drum apparatus, and magnetic tape recorders. The data memory 47 stores therein design pattern data. The design pattern data is stored in a manner that the entire inspection area of a reticle is divided into strip-like partial areas—say, subareas. The design pattern data is preparable by the expander 43 and referencer 44 from the design data of reticle 2, as a reference image which is resembled to the optical image. This reference image is sent to the comparison processor.5 for DB comparison with the optical image. Note that the pattern inspection apparatus 1 is configurable by electronic circuitry, software program, personal computer (PC) or any combinations thereof.

The pattern inspection apparatus 1 also includes an input unit (not depicted) for accepting entry of data and/or commands from an operator and an output unit (not shown) for output of inspection results while the data memory 47 stores design pattern data whereas the program memory 48 stores an inspection program(s). The input unit is arranged by a keyboard, a pointing device known as the “mouse,” a light pen called a stylus, or a floppy diskette drive (FDD). The output unit may be a display device and/or a printer machine.

The pattern inspection apparatus 1 offers calibration capabilities. Upon acquisition of a fiducial or “base” image used for initial inspection, obtain calibration-use data indicative of a state or else of the pattern inspection apparatus 1. Then, store it in an appropriate memory device, such as a calibration data storage memory device 61. During deterioration testing, the calibration data obtained by the pattern inspection apparatus 1 is used to perform calibration, thereby enabling adjustment or “recovery” to the state at the time of initial inspection.

### Optical Image Acquisition Unit

The optical image acquisition unit 3 acquires the optical image of a reticle 2, which is mounted on the XYθ table 34. The XYθ table 34 may be a three-axis (X-Y-θ). manipulator that is movable in the X and Y directions and also rotatable by an angle θ under control of the table controller 41, which operates in response to receipt of a command from the CPU 40. Table drive/control for movement in the X direction is made by the X motor 343; table motion in Y direction is by Y motor 344. Rotation by angle θ is done by θ motor 342. Examples of these X, Y and θ motors are servo motors or stepper motors of the known type. The coordinates of a present position of the XYθ table 34 are measured, for example, by the laser-assisted length measurement system 341 so that its output is sent to the position unit 46. This unit generates at its output a table position coordinate data signal, which is fed back to the table controller 41.

The reticle 2 is automatically transferred to and mounted on the XYθ table 34 by auto-loader (not shown) and, after inspection, automatically unloaded thereby. A light source 31 and its associated light irradiation unit are located over XYθ table 34. The light source 31 emits light, which is guided by a condenser lens assembly to fall onto the reticle 2 as a focused light beam. At a location underlying the reticle 2, a signal detection unit is placed, which includes a magnifying optical lens assembly 32 and a photodiode (PD) array 33. The light that passed through reticle 2 is focused by the magnifier optics 32 onto a photosensitive surface of the PD array 33. The optics 32 is subjected to automatic focus adjustment by a focus adjuster device (not shown), which includes piezoelectric elements or the like. This focus adjuster is operation-controlled by an auto-focus control circuit (not shown), which is connected to the CPU 40. The focus adjustment may alternatively be monitored by a separately provided observation scope. The PD array 33 for use as a photoelectric conversion unit may be a linear array of multiple photosensors or an area sensor having a matrix of rows and columns of PDs. While letting the XYθ table 34 move continuously, PD array 33 detects a measurement signal corresponding to a sensed image of the. reticle 2's region of interest, which is under inspection.

This measurement signal is converted by the sensor circuit 35 into digital data, which is then passed to the buffer memory 36 as the data of the optical image sensed. The buffer memory 36 may be an ensemble of more than two semiconductor memory modules. The data as output from buffer memory 36 is sent to the comparison processing unit 5. An example of the image data is eight (8) bits of signless data indicative of the brightness of each picture element or “pixel.” The pattern inspection apparatus 1 of this type is typically operable to read the pattern data out of the PD array 33 in a way synchronized with a clock frequency of about 10 to 30 megahertz (MHz), get them lined up to provide an adequate form of data, and handle as raster-scanned two-dimensional (2D) image data.

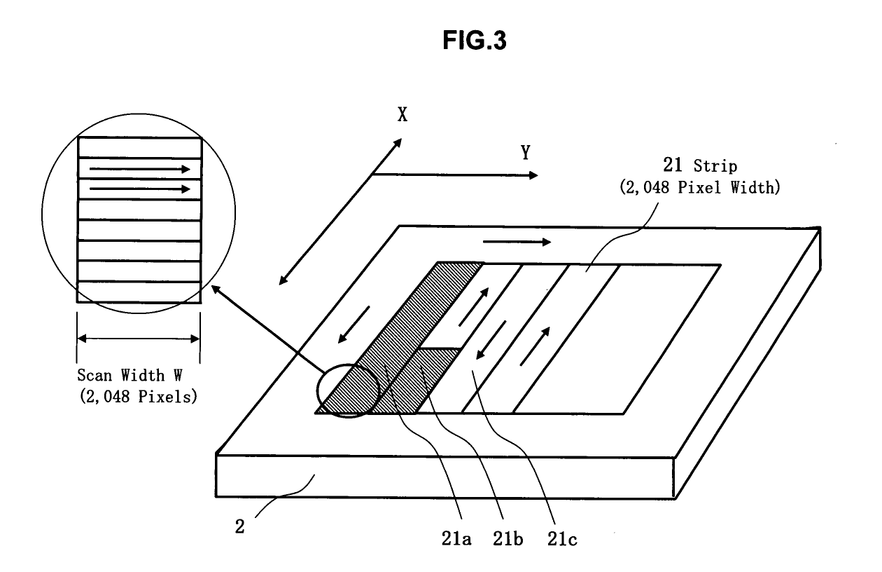

Turning to FIG. 3, an exemplary optical image acquisition procedure is shown. The reticle 2's pattern area to be inspected is virtually divided into a plurality of strip-like narrow rectangular subareas 21 each having a scan width W along the Y direction. To continuously scan these divided strips 21, the XYθ table 34 is driven to move in the X direction under control of the table controller 41. In a way synchronized with such table movement, the light beam scans respective strips 21 so that their optical images are captured by the PD array 33. The PD array 33 captures these images of the scan width W continuously or “seamlessly.” More specifically, after having sensed the image of a first strip 21a, the PD array 33 captures the image of a second strip 21b in a similar way to that of strip 21a but in the direction reverse to that during acquisition thereof. A third strip 21c is image-captured in the direction reverse to that of the image acquisition of second strip 21b, that is, in the same direction as that of first strip 21a. With such the seamless “serpentine” image capturing scheme, a time as taken to pick up the entire reticle pattern area is shortened or minimized while avoiding any waste processing time. Note here that the scan width W is set to a length corresponding to a total size of 2,048 pixels as an example.

Respective sets of measured pattern data of the reticle strips 21 as output from the sensor circuit 35 are sent to the comparison processor unit 5 along with the output data of position unit 46 indicative of a present position of the reticle 2 on the XYθ table 34. An optical image to be compared is cut into partial areas of an appropriate size; for example, regions each having a matrix of 512 by 512 pixels. Although the optical image is captured here by using the light that passed through the reticle 2, similar results are obtainable by use of reflection light, scattered light, polarized scatter light, or polarized transmission light. In particular, in the case of a reticle 2 with possible surface deterioration, appreciable effects are attainable by using images of light as reflected at the reticle surface. To sense these image light rays, the image acquisitor 3 has a prior known capturing mechanism that obtains images of light, such as reflected light, scattered light, polarized scatter light, polarized transmission light or else. Very importantly, the optical image acquisitor 3 has calibration functionality for permitting acquisition of calibration-use data (correction data) when obtaining a fiducial image at the time of initial inspection, which data will be stored in a given memory device, such as a calibration data storage memory 61 or else. The optical image acquisitor 3 is also operable to use the calibration data obtained by the calibration function to perform adjustment through calibration to the state in the initial inspection event during deterioration testing.

### Preparing Reference Image

A reference image is an image that was prepared to have much similarity to the optical image by execution of various conversion processes from the design data of the reticle 2. The reference image is preparable, for example, by the expander 43 and referencer 44 shown in FIG. 2. The expander 43 reads out of the data memory 47 the design data of the pattern image of reticle 2 under control of CPU 40 and then converts the read data into image data. The referencer 44 is responsive to receipt of the image data from expander 43, for performing image resembling processing—e.g., rounding corner edges of graphics, gradating or “fogging,” or other similar suitable image manipulation—to thereby create the reference image.

### Comparison Processor

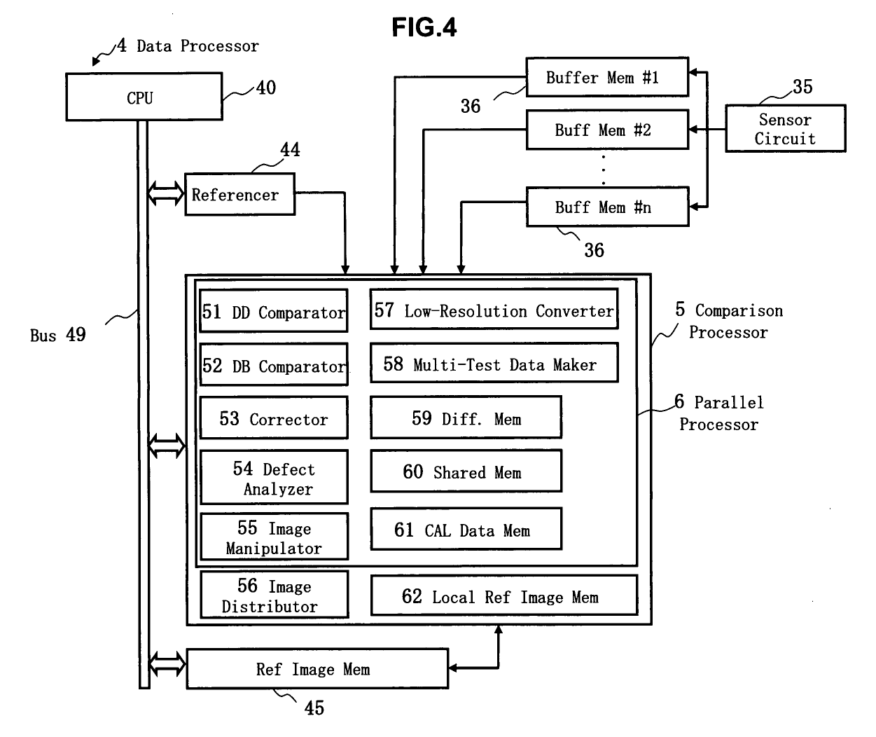

An internal configuration of the comparison processor unit 5 is shown in FIG. 4. The comparison processor 5 is the one that performs comparison between images and executes reticle deterioration inspection. Comparison processor 5 is generally made up of a comparator unit having the DD comparator 51 and DB comparator 52, a correction processing unit 53, a defect analyzer unit 54, an image manipulation unit 55, an image distributor 56, a low-resolution converter 57, a multi-test data creation unit 58, a difference memory device 59, a common or “shared” memory device 60, a calibration data storage memory device 61, and a local fiducial image storage memory device 62. The image distributor 56 divides an image into a plurality of portions or alternatively performs alignment of multiple image segments. Preferably, such image segments distributed by image distributor 56 are processed in a parallel fashion, thereby making it possible to increase the processing speed. The low-resolution converter 57 lowers the image resolution to thereby lessen the data quality, thus enabling speedup of the processing, such as comparison processing or the like.

The comparison processor 5 is configurable to have a plurality of built-in parallel processing modules. This parallel processor 6 functions to perform more than two processing tasks at a time. Parallel processor 6 includes, but not limited to, a comparator having DD comparator 51 and DB comparator 52, correction processor 53, defect analyzer 54, image manipulator 55, low-resolution converter 57, multi-test data creator 58, difference memory 59, shared memory 60, and calibration data storage memory 61, which are rendered operative to do tasks in a parallel way.

The DD comparator 51 performs comparison between optical pattern images of the reticle 2 as obtained by the optical image acquisitor 3—for example, compares a pattern image under inspection to the fiducial image of optical image. The DB comparator 52 compares an optical image to reference image. An image indicative of a difference between the DB comparison-obtained optical image and the reference image is stored in the difference memory 59. The DD comparison and DB comparison are capable of detecting variations in light transmissivity, foreign matter attached, precise edge positions and ultra-small changes in intensity, thereby sensing reticle deterioration, if any. Additionally the comparison processor 5 performs comparison of ultrasmall shapes, such as contact holes, while performing setup of a margin pursuant to the materiality of graphics and the sensitivity of a region of interest in conformity with graphic features, thereby offering more accurate and definite deterioration testing capabilities. The multi-test data creator 58 is designed to create at least one of the transmissivity, light intensity, line width and edge roughness and also perform comparison thereof. Preferably the multi-test data creator 58 has a plurality of testing functions of the transmissivity, light amount, line width and edge roughness. Thus more precise testing is enabled.

### Correction Processor

The correction processor unit 53 performs the testing of photomasks of the type having non-exposed regions, such as pellicle-added masks, which unit is designed to do testing even for anti-exposure mask areas which are free from deterioration without doubt. The corrector 53 generates at its output a calibration image to be later used during testing in future, which is stored in a memory device, such as the calibration data memory 61. Then, compare the calibration image of non-exposure region(s) to a uniformly deteriorated portion(s) due to exposure, thereby determining through computation an exact level of due-to-exposure deterioration; next, correct or “amend” the fiducial image so that it has a uniform deterioration level. The computation of such uniform exposure-caused deterioration level is achievable by maximum sensitivity comparison techniques using the calibration data.

### Image Manipulator

The image manipulation unit 55 performs image manipulation in a such a way as to enable accurate comparison of the fiducial image and an image being inspected. Image manipulator 55 offers executability of a variety of types of image manipulation tasks including, but not limited to, distortion and expansion/shrink plus wobbling along with SIM processing. The SIM processing is a simulation process, such as image resolution conversion, production of a synthesis image by combining together a plurality of images, emphasized image creation, transferable processing, etc. The image manipulation is executable by the data processor unit 4 or alternatively at the comparison processor 5.

### Pattern Inspection Method

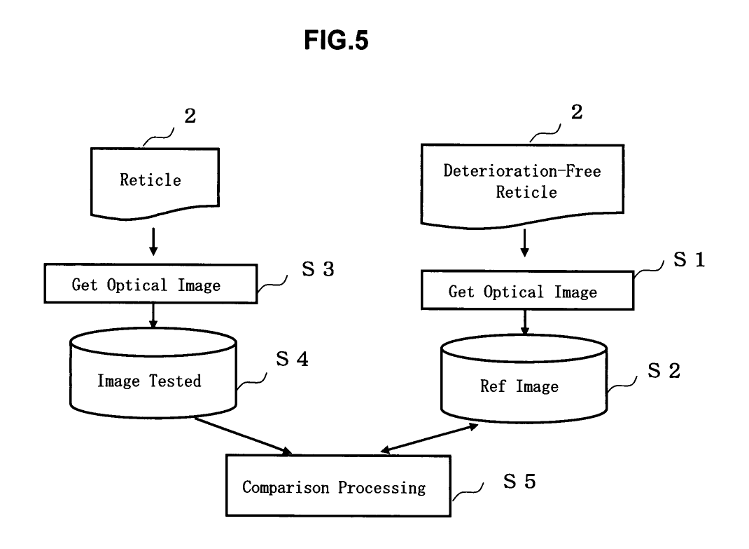

FIG. 5 shows a pattern inspection method also embodying this invention. This inspection method starts with step S1, which loads a deterioration-free reticle into optical image capturing equipment and then acquires its optical image as the fiducial image. Then, the procedure goes to step S2, which temporarily stores the fiducial image in the memory device 45. Thereafter, at step S3, load and mount in the optical image acquisition equipment a reticle that is the same as the fiducial image-captured reticle, for capturing its optical image as an image to be tested. Next, go to step S4 which stores the to-be-tested image in the memory device 36. Subsequently, go to step S5 which compares the to-be-tested image to the fiducial image to thereby check a deterioration state thereof. The reticle is processed through these steps S1 to S5, resulting in detection of defects grown on the reticle. This ensures obtainment of a useful reticle. In addition, processing the reticle by these steps S1-S5 makes it possible to achieve accurate reticle management.

To ameliorate or “cure” the reticle's deterioration, wash and rinse the reticle of interest. Then, an image of the washed and rechecked reticle is stored in the calibration data storage memory 61, together with testing conditions and test result data. For example, the initial test image and the retested image along with the test conditions at that time and test result data are saved together in the fiducial image storage memory device. Whereby, it is possible to additionally perform the testing of reticle deterioration simultaneously, such as pattern thinning due to the washing. It is also possible to determine whether the reticle washing is appropriate or not in the aftertime.

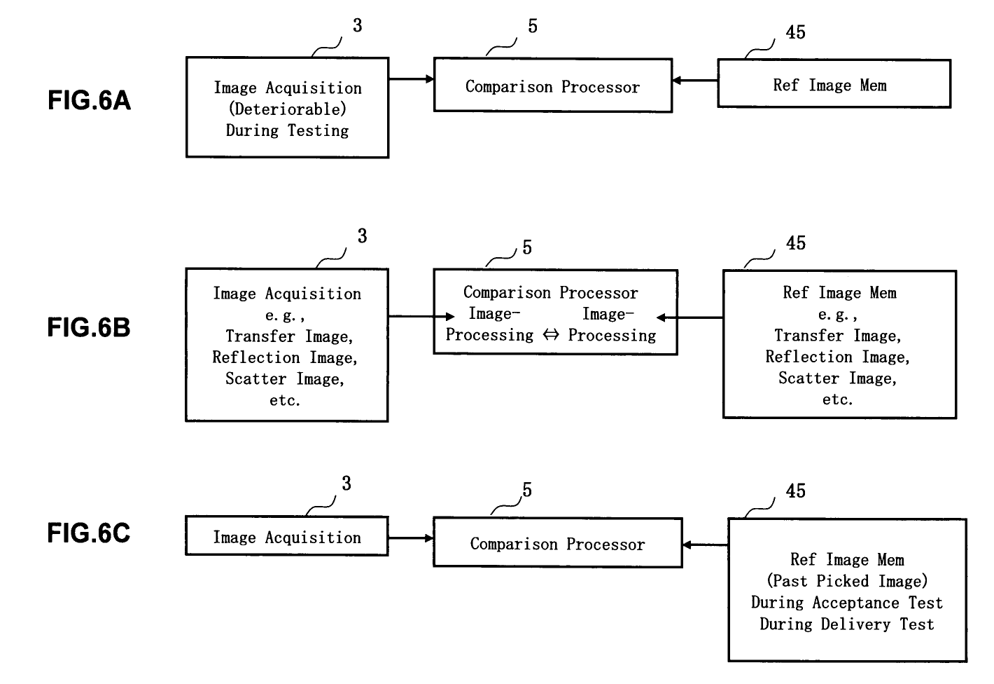

FIGS. 6A to 6C show basic process examples of the inspection method. In particular, FIG. 6A shows the basics of reticle deterioration testing. While using as the fiducial image the optical image free from deterioration risks being stored in the fiducial image storage memory device 45, the comparison processor 5 compares thereto an optical image (i.e., image with possible deterioration risks) as acquired by the optical image acquisition unit 3 during deterioration testing, thereby performing pattern inspection. An extended version of the pattern inspection is shown in FIG. 6B. First, acquire in the fiducial image storage memory device 45 the image of a deterioration-free reticle region in the form of a transfer image, reflection image, scatter image, polarized scatter image, polarized transfer image or phase-emphasis image. Then, store it as a fiducial image. Next, during deterioration testing, capture an image with deteriorability as a transfer image, reflection image, dispersion image, polarized dispersion image, polarized transfer image or phase-emphasis image. Let this optical image be an image to be tested. The fiducial image and the to-be-tested image are corrected or “amended” together by SIM processing or else. Subsequently, the comparison processor 5 compares these corrected fiducial image and to-be-tested image, thereby performing inspection to determine a deterioration state.

A process of FIG. 6C is to capture a reticle pattern area with no deterioration as a “past” image in the manufacture of reticles or in the course of product delivery inspection or acceptance testing. In this event, in order to compensate for possible variations with time of the pattern inspection apparatus 1, the calibration-use data is also obtained and then saved in a given memory device—e.g., the calibration data storage memory device 61. During deterioration testing, capture an optical image, which is handled as an image to be tested. Next, let the comparison processor 5 compare the to-be-tested image to the fiducial image, thereby performing pattern inspection. In this comparison session, using the saved calibration data makes it possible to perform the intended pattern inspection with enhanced accuracy. This deterioration testing is principally self-comparison inspection, so mask errors hardly occur, thereby making it possible to detect with high sensitivity any growing defects at the initial stage thereof. Furthermore, superior signal-to-noise (S/N) ratios are attainable, which enables execution of low-resolution inspection at high speeds. The resultant reticle obtained by the inspection method is such that the growing defects are detectable in early stages, so it is possible to obtain effective reticles. Additionally, a reticle management method using this inspection method is capable of early detecting the growth of reticle defects, thereby enabling successful handling of pattern image deterioration. Thus it is possible to properly manage reticles.

### EMBODIMENT 1

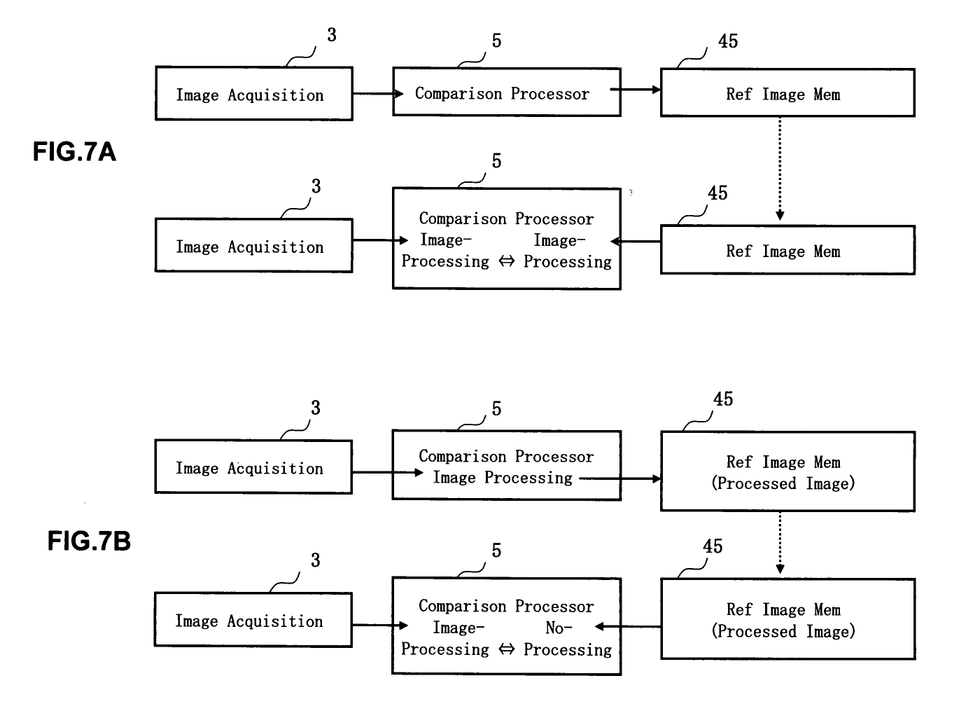

An exemplary processing procedure in the initial inspection and deterioration testing events is shown in FIG. 7A. As shown herein, a reticle 2 is scanned at the optical image acquisition unit 3, thereby obtaining its deterioration-free pattern area (i.e., the image without degradation risks), which is then saved in the fiducial image storage memory device 45 by way of the comparison processor 5. Next, capture a to-be-tested image by scanning the reticle 2 that is deteriorable during deterioration testing. Then, compare this captured to-be-tested image to the fiducial image being presently saved in the fiducial image memory 45. Prior to this comparison, apply image correction, such as SIM processing, to the fiducial image and the image under testing. Then compare a corrected version of the test image to the corrected fiducial image, thereby performing pattern inspection. Another exemplary processing procedure is shown in FIG. 7B, which is similar to that of FIG. 7A except for a difference in timing of the calibration processing. More specifically, in the FIG. 7B procedure, a deterioration-free reticle is scanned to get an optical image thereof. This image is then applied image manipulation at the comparison processor 5; then, let the resultant image be stored as a fiducial image in the fiducial image memory 45. Next, a deteriorable reticle is scanned whereby its optical image is captured as a to-be-tested image, which is then applied image manipulation at comparison processor 5. A deterioration state of the resulting corrected test image is detectable by comparing it to the fiducial image that has already been corrected.

### EMBODIMENT 2

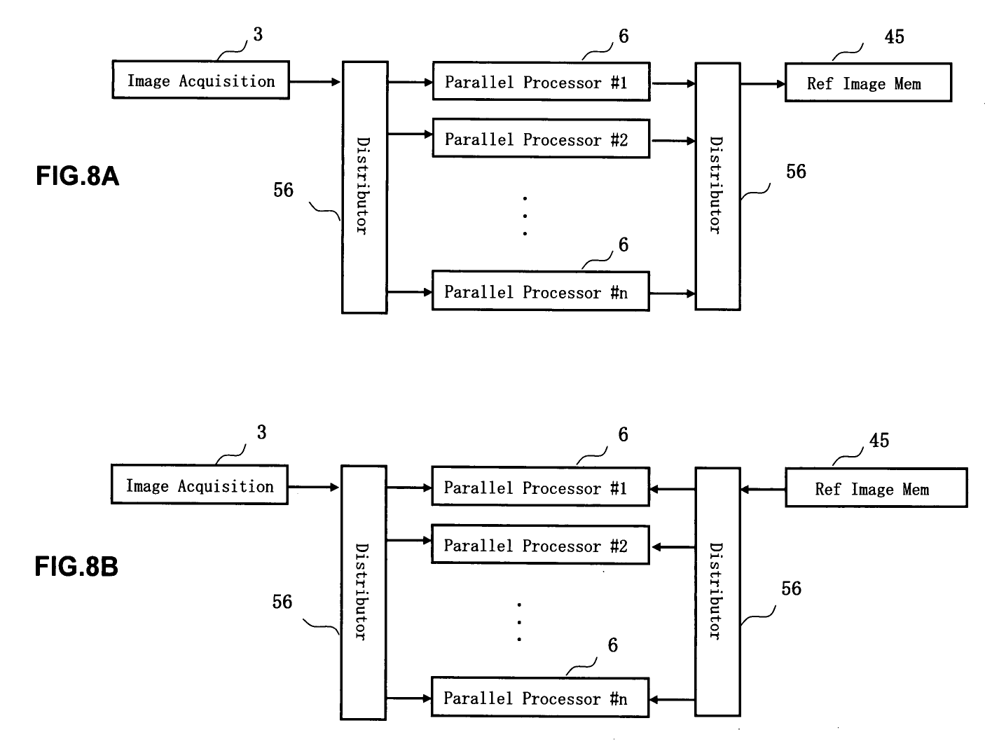

An exemplary deterioration testing technique using the parallel processing unit 6 is shown in FIG. 8A. Firstly in an acceptance inspection event, a reticle is scanned by the optical image acquisition unit 3 to thereby gain an optical image of its entire test area. Then, this optical image is divided by the image distributor 56 into a plurality of partial areas or “subareas,” which are distributed to a parallel combination of processor modules 6-1 to 6-n in the parallel processing unit 6. Next, the parallel processor 6 applies to each subarea the intended image manipulation, such as image density level adjustment, distortion curing, expansion/shrink, wobbling and/or SIM processing, in a parallel way. The resulting images of respective processed subareas are then combined together by image distributor 56 into a synthetic image indicative of an entire reticle pattern area under inspection, which is then saved in a one memory, i.e., the fiducial image storage memory device 45. Another procedure is shown in FIG. 8A.

During deterioration testing, an optical image of the reticle pattern to be tested is captured by the optical image acquisitor 3 and is then divided by the image distributor 56 into subareas. Read the saved fiducial image out of the fiducial image memory 45 and then divide it into an equal number of subareas. The reticle subareas and the fiducial image subareas are distributed to a set of parallel processors 6-1 to 6-n in a way such that a reticle subarea and its corresponding fiducial image subarea are passed to a parallel processor 6i (where., “i” is an integer 1, 2, . . . , or n). Respective reticle/fiducial-image subarea pairs are compared together at parallel processors 6-1 to 6-n at a time—namely, in a parallel fashion—to thereby inspect the reticle for deterioration.

### EMBODIMENT 3

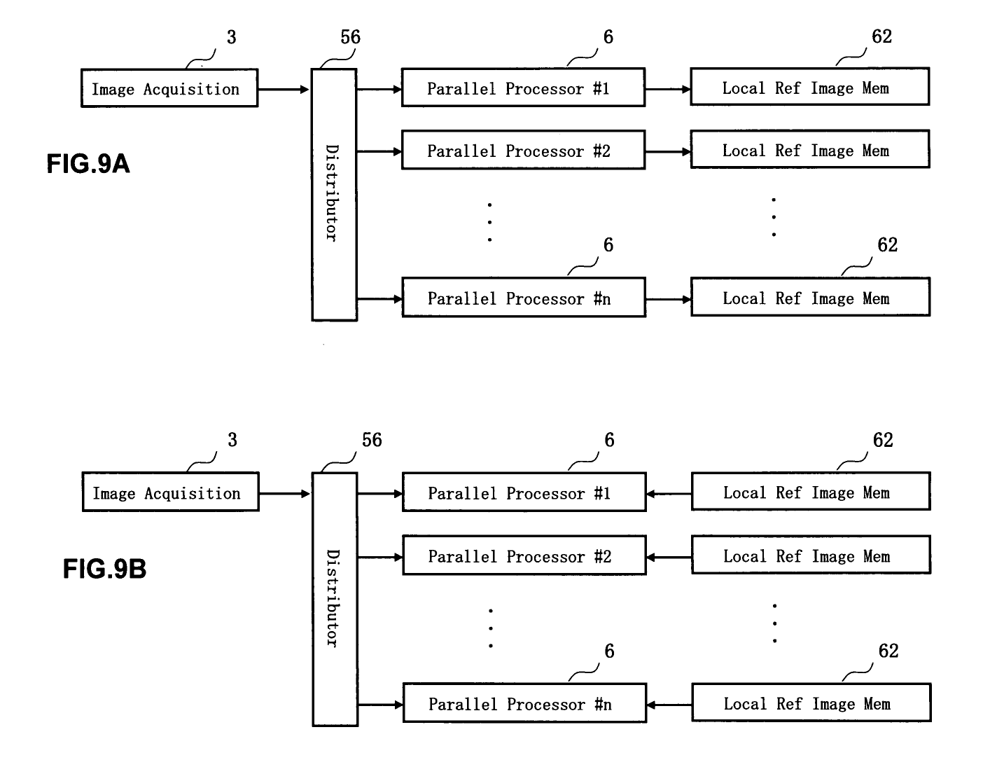

An exemplary reticle pattern deterioration inspection method using the parallel processing subunits 6-1 to 6-n is shown in FIG. 9A. This example is similar to that of FIG. 8A with the fiducial image storage memory device 45 being made up of a parallel combination of local fiducial image storage memory modules 62, which are the same in number as the parallel processors 6-1 to 6-n, thereby offering an ability to store the fiducial image subareas that are divided by the image distributor 56 in these memories 62 on a per-subarea basis. With the “per-subarea image storage” feature, it is possible to directly save, with no changes added thereto, those subareas obtained by distribution of an entire to-be-tested reticle area image in the local fiducial image memories 62, respectively. This configuration is modifiable as shown in FIG. 9B to permit direct comparison of the subarea images as read from local fiducial image memories 62 to their corresponding subarea images of the to-be-tested image in a parallel way. In the examples of FIGS. 9A-9B, the fiducial image is locally storable, so it becomes possible to achieve the deterioration testing while reducing complexity. Additionally these examples of FIGS. 9A-B are arranged to use the parallel processor unit 6 so that the calibration is executable by high-speed parallel processing machinery. Alternatively it is possible to locally close-couple the image storage mechanism to its associative processing system.

It should be noted that in Embodiment 3, an optical image of high resolution is acquired at the optical image acquisitor 3 by using the process of FIG. 9A during fiducial-image capturing. The optical image is split into multiple partial images at the image distributor 56, which are then applied manipulation for low-resolution conversion at the parallel processors 6. Resultant low-resolution converted partial images are stored in the local fiducial image memories 62. Then go to the process of FIG. 9B during deterioration testing, which allows optical image acquisitor 3 to get a low-resolution optical image as the to-be-tested image. Then, let this to-be-tested image be divided by image distributor 56 into partial images. Next, compare these partial images of the to-be-tested image to partial images of the fiducial image being presently saved in local fiducial image memory modules 62 at a time, thereby performing the deterioration testing. By converting the images to have low resolutions, it becomes possible to speed up the inspection.

Also note that in any one of the processes of FIGS. 9A-9B, the fiducial image and the to-be-tested image are acquired at the optical image acquisitor 3 as transfer images, reflection images, scatter images, polarized scatter images, polarized transfer images or phase-emphasis images for being subject to the comparison processing at the parallel processors 6-1 to 6-n.

Additionally in Embodiment 3, the image obtained as the fiducial image is “decomposed” into partial images, which are passed to the parallel processors 6-1 to 6-n for being applied the image manipulation, such as SIM processing, followed by storage of resultant image data in the local fiducial image memories 62. Examples of such stored images are light-intensity distribution images, developed images, and transferred images. Next, let an image obtained as the to-be-tested image during inspection be divided by image distributor 56 into partial images, which are then applied the image manipulation, such as SIM processing, at the parallel processors 6-1 to 6-n in a parallel way. Then compare the partial images of the to-be-tested image thus manipulated to corresponding parts of the fiducial image being stored in the local fiducial image memories 62, thereby performing the deterioration inspection.

### EMBODIMENT 4

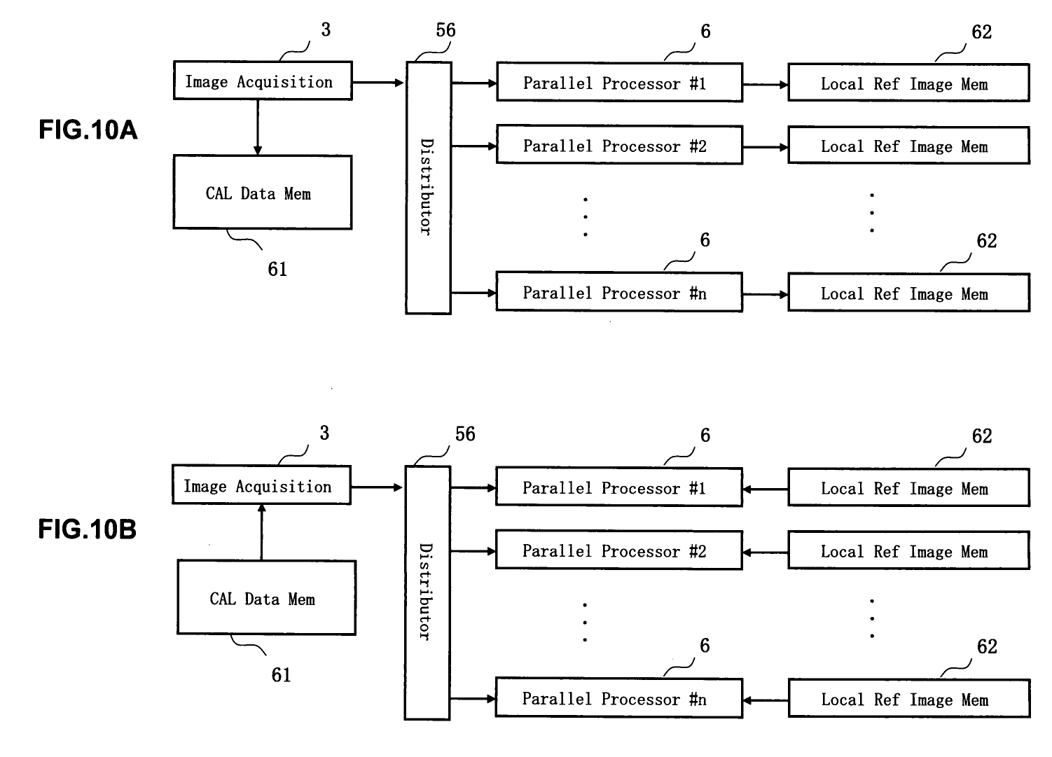

Turning to FIG. 10A, a reticle deterioration inspection method using the parallel processor units 6-1 to 6-n is shown. This method is similar to that of FIG. 9A except that the former obtains a calibration-use image(s) and data in addition to the acquired image. At the time the initial testing is done, the optical image acquisitor 3 acquires a fiducial image along with a calibration image and data. The calibration image and data are saved in the calibration data memory device 61. The fiducial image is divided by image distributor 56 into partial images, which are stored in the local fiducial image memories 62, respectively. During deterioration testing, optical image acquisitor 3 reads the calibration image and data out of memory 61 and use them to acquire an image to be tested. Then, let the to-be-tested image be divided into partial images. Next, let the parallel processors 6-1 to 6-n to compare them to corresponding partial images of the fiducial image as read from the calibration data memory device 61 at a time. A process of FIG. 10B is similar to that of FIG. 9B with similar changes to FIG. 9A being added thereto.

While the invention has been described with reference to specific embodiments, the description is illustrative of the invention and is not to be construed as limiting the invention. For example, the embodiments having parallel processor units are modifiable and alterable to have the applicability to pattern inspection machinery with the lack of such parallel processors.

What is claimed is:

1. A pattern inspection apparatus comprising:
an image acquisition unit operative to gain a first optical image of a workpiece to be inspected and then capture a second optical image of the workpiece;
a first storage device for storing therein the first image as a fiducial image;
a second storage device for storing the second image as an image to be tested; and
a comparison processing unit for comparison between the fiducial image and the image to be tested in a way that the fiducial image of the workpiece as read out of said first storage device is compared to the to-be-tested image of the workpiece as read from said second storage device.

2. The apparatus of claim 1 further comprising:
a third storage device operative to store therein calibration data including any one of an inspection condition for acquisition of the fiducial image and a test result.

3. The apparatus according to claim 1, wherein the fiducial image is an optical image of the workpiece being inspected as acquired by said optical image acquisition unit in a past time, and wherein the to-be-tested test image is an optical image of the workpiece as obtained by said optical image acquisition unit during inspection.

4. The apparatus according to claim 1, wherein the fiducial image is an optical image being substantially equivalent to an originally prepared image of the workpiece as acquired by said optical image acquisition unit, and wherein the to-be-tested image is an optical image with deterioration risks of the workpiece as gained by said optical image acquisition unit during inspection of the workpiece.

5. The apparatus according to claim 1, further comprising:
an image processing unit for applying image processing to the fiducial image and the to-be-tested image when comparing the to-be-tested image to the fiducial image.

6. The apparatus according to claim 1, wherein said optical image acquisition unit includes a mechanism for gaining at least one of a transmission image, a reflection image, a scatter image, a polarized scatter image, a polarized transmission image and a phase-emphasis image, and wherein each of the fiducial image and the to-be-tested image is any one of the transmission image, the reflection image, the scatter image, the polarized scatter image, the polarized transmission image and the phase-emphasis image.

7. The apparatus according to claim 1, wherein said comparison processing unit has a mechanism for creation and comparison of a transmission factor, a light amount, a line width and an edge roughness.

8. The apparatus according to claim 1, further comprising:
a correction processor unit for comparing together anti-exposure regions of the to-be-tested image and the fiducial image and for correcting the fiducial image to have a uniform deterioration level.

9. The apparatus according to claim 1, further comprising:
a die-to-database (“DB”) comparison unit for comparison between a reference image created from design data and an optical image as gained at said optical image acquisition unit; and
a difference memory device for storing a difference image as obtained by DB comparison of the fiducial image.

10. The apparatus according to claim 1, wherein said optical image acquisition unit has a calibration function, and wherein the to-be-tested image is gained by calibration of said optical image acquisition unit to a state at the time the fiducial image was acquired by said optical image acquisition unit.

11. The apparatus according to claim 1, further comprising:
an image distribution unit for performing image distribution; and
a parallel processor unit for applying parallel processing to each partial image distributed.

12. The apparatus according to claim 11, wherein said parallel processor unit includes an image processor unit for performing image processing and for causing each partial image as distributed from the fiducial image to undergo image processing in a parallel way.

13. The apparatus according to claim 11, further comprising:
a plurality of local fiducial image storage memory devices for storing a plurality of partial images as distributed from the fiducial image.

14. The apparatus according to claim 11, further comprising:
a low-resolution converter unit operative associated with said parallel processor unit, for converting an image to have a decreased resolution, wherein the plurality of partial images distributed from the fiducial image are applied low-resolution conversion in a parallel way and are stored in respective fiducial image storage memory devices.

15. A pattern inspection method comprising:
gaining as an image to be tested an optical image of a workpiece being inspected; and
comparing the test image to an optical image of the workpiece as has been previously acquired as a fiducial image.

16. The method according to claim 15, further comprising:
acquiring an optical image of the workpiece as a fiducial image in any one of acceptance and delivery inspection events; and
acquiring an optical image of the workpiece as a test image after having used the workpiece.

17. The method according to claim 15, further comprising:
applying image processing to the fiducial image and the test image; and
comparing together the test image and the fiducial image thus image-processed.

18. The method according to claim 15, wherein each of the fiducial image and the test image is acquired as any one of a transmission image, a reflection image, a scatter image, a polarized scatter image, a polarized transmission image and a phase-emphasized image.

19. The method according to claim 15, further comprising:
comparing anti-exposure regions of the test image and the fiducial image to thereby correct the fiducial image to have a uniform deterioration level.

20. The method according to claim 15, further comprising:
dividing for distribution each of the fiducial image and the test image into a plurality of partial images; and
comparing, in parallel, the partial images of the fiducial image and those of the test image.
